(19) United States
(12) Patent Application Publication
(10) Pub. No.: US 2003/0210678 A1
(43) Pub. Date: Nov. 13, 2003

(54) Functionality split between mobile terminal and terminal equipment for internet protocol multimedia signal exchange

(75) Inventor: Tao Haukka, Oulu (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/144,240

(22) Filed: May 10, 2002

(51) Int. Cl. H04L 12/66; H04L 12/28

(52) U.S. Cl. 370/352; 370/401

(57) ABSTRACT

The present invention provides a method and apparatus for connecting terminal equipment to a wireless network with a mobile terminal, wherein the mobile terminal is assigned proxy functions that control access of the terminal equipment to an internet protocol multimedia subsystem (IMS) in the wireless network. The proxy control functions include identification or authentication functions, as well as call control functions. The terminal equipment performs protocol stream processing functions for communicating with the internet protocol multimedia subsystem (IMS). The protocol stream processing functions include real-time transport protocol (RTP) and real-time transport control protocol (RTCP) functions. The wireless network includes a universal mobile telecommunications system (UMTS) network coupled to the internet protocol multimedia subsystem (IMS). The internet protocol multimedia subsystem (IMS) includes a session initiation protocol (SIP) server for providing internet protocol multimedia information signals.

### BACKGROUND OF THE INVENTION

1. Field Of Invention

The present invention relates to a mobile terminal or phone; and more particularly relates to a method and apparatus for connecting terminal equipment to a wireless network with a mobile terminal.

2. Description of Related Art

FIG. 1 shows a known method and apparatus for connecting the terminal equipment (TE) 10 to a wireless network generally indicated as 12 with a mobile terminal (MT) or phone 14. The wireless network 12 includes a universal mobile telecommunications system (UMTS) network 16 coupled to an internet protocol multimedia subsystem (IMS) 18. The universal mobile telecommunications system (UMTS) network 16 includes a gateway general packet radio system support node (GGSN) 20, while the internet protocol multimedia subsystem (IMS) 18 includes a session initiation protocol (SIP) server 22 to handle call state control functions.

Currently, in the general packet radio system (GPRS) the mobile terminal 14 is a dumb radio modem and the terminal equipment 10 fully controls the mobile terminal 14. The terminal equipment 10 may typically be a laptop, notebook computer or other personal computing device. In operation, the terminal equipment 10 handles all applications and fully controls the mobile terminal 14.

However, there are disadvantages with this known architecture, as follows:

First, the terminal equipment 10 needs to learn relevant knowledge related to the third generation partnership project (3GPP) such as the open packet data protocol (PDP) context and 3GPP SIP grammar, which does not provide an open platform for all types of terminal equipment to plug-in.

Second, there are also security concerns if the terminal equipment 10 can access the Universal Subscriber Identity Module (USIM) card or the Universal Integrated Circuit Card (UICC) of the mobile terminal 14. When security starts in the terminal equipment 10, all calling details are sheltered from the mobile terminal 14. However, it is believed that the authentication function is essential for all SIP based services e.g. Presence, Instant Message, Chat.

Moreover, consistent with the Internet Engineering Task Force publication no. TS 33.103, the following security parameters should be kept in the USIM/UICC card:

(1) K: a permanent secret key;

(2) SQN_{MS}: a counter that is equal to the highest sequence number SQN in an authentication (AUTN) parameter accepted by the user;

(3) RAND_{MS}: the random challenge which was received together with the last AUTN parameter accepted by the user (It is used to calculate the re-synchronization message together with the highest accepted sequence number (SQN_{MS}));

(4) KSI: Key set identifier;

(5) THRESHOLD_{C}: a threshold defined by the TE to trigger re-authentication and to control the cipher key lifetime;

(6) CK: The access link cipher key established as part of authentication;

(7) IK: The access link integrity key established as part of authentication;

(8) HFN_{MS}: Stored Hyper Frame Number provides the initialization value for most significant part of COUNT-C and COUNT-I (The least significant part is obtained from the radio resource control (RRC) sequence number);

(9) AMF: A 16-bit Authentication Management Field (The use and format are unspecified in the architecture but examples are given in an informative annex); and

(10) The GSM authentication parameter and GSM cipher key derived from the UMTS to GSM conversion functions. However, there is no specification for UICC to keep the parameters of the terminal equipment 10 in a separate application. To support the terminal equipment 10 accessing the internet protocol multimedia subsystem (IMS) 18, the mobile terminal 14 has to maintain at least the above parameters in the mobile terminal 14. From a security point of view, this is unsecured to store all confidential parameters to the terminal equipment 10 instead of the UICC card, and it is also cumbersome for the software implementation in the mobile terminal 14. Furthermore, to guarantee the reachability of the mobile terminal 14 (calling or to be called) simultaneously, the mobile terminal 14 must reserve at least 3 PDP contexts capacity (SIP—receiving INVITE, audio and video streams) which leaves rather small space for traffic processing in the terminal equipment 10.

For these reasons, there is a need in the industry for an improved architecture to that known in the art.

### SUMMARY OF INVENTION

In its broadest sense, the present invention provides a new and unique method and apparatus for connecting terminal equipment to a wireless network with a mobile terminal. According to the present invention, the mobile terminal is assigned proxy functions that control access of the terminal equipment to the wireless network. In operation, the proxy functions include the mobile terminal providing identification signals from the terminal equipment to the wireless network and application signals between the terminal equipment to the wireless network, so as to act as an intermediary between the terminal equipment and the wireless network. In one embodiment, the proxy functions control access of the terminal equipment to an internet protocol multimedia subsystem (IMS) in the wireless network. The proxy functions include identification or authentication functions, as well as call control functions.

The terminal equipment performs multimedia stream processing functions for communicating with the internet protocol multimedia subsystem (IMS). The multimedia stream processing functions includes real-time transport protocol (RTP) and real-time transport control protocol (RTCP) functions.

The wireless network includes a universal mobile telecommunications system (UMTS) network coupled to the internet protocol multimedia subsystem (IMS). The internet protocol multimedia subsystem (IMS) includes a session initiation protocol (SIP) server for providing internet protocol multimedia information signals.

The mobile terminal retrieves identification information from the terminal equipment if there is any previously defined, which may include adaptive multi-rate (AMR) codec information and real-time transport protocol (RTP) ciphering/deciphering capability information. After receiving the identification information, the mobile terminal starts a connection to and negotiates capacity with the wireless network. The mobile terminal also considers the identification information as identifying itself and does not make any other mobile originated (MO) connections; declares the real-time transport protocol (RTP) session parameters and corresponding packet data protocol (PDP) contexts on behalf of the terminal equipment and handles the quality of service (QoS) independently; and starts a session initiation protocol (SIP) and declares real transport protocol (RTP) session parameters and corresponding packet data protocol (PDP) contexts on behalf of the terminal equipment. The mobile terminal may also selectively change any real-time transport protocol (RTP) session parameter. After initiation is completed, the mobile terminal would store the identification information of the terminal equipment.

In effect, the present invention transfers the capability of the terminal equipment to the mobile terminal. On the other hand, the mobile terminal should have a corresponding application to interpret the conversation and forwarding scheme to activate the real-time transport protocol (RTP) playing in the terminal equipment. The terminal equipment side application is activated first, then the terminal equipment capability information is sent to the mobile terminal via any available link connection between the terminal equipment and the mobile terminal. The mobile terminal creates a record in its phone memory to store the terminal equipment's capability information. When a media session is agreed upon, the mobile terminal activates the real-time transport protocol/real-time transport control protocol (RTP/RTCP) processing of the terminal equipment.

This new and unique internet protocol routing (IPR) scheme enhances the mobile terminal's controller role by assigning identification function to the mobile terminal, so that terminal equipment works as an accessory of the mobile terminal and is controlled by the mobile terminal.

The advantages of the present invention include the following:

First, the mobile terminal is the one to be identified and billed in the connection between the terminal equipment to mobile terminal so as to provide centralized access and billing control. Meanwhile, the public identification (ID) of the terminal equipment can be used in other access network with or without the mobile terminal, for example in wireless local area networks.

Second, the terminal equipment does not need to learn third generation partnership project (3GPP) relevant knowledge such as open packet data protocol (PDP) context, 3GPP session initiation protocol (SIP) grammar, but only the Internet Engineering Task Force (IETF) specified real-time transport protocol/real-time transport control protocol (RTP/RTCP) stream, which is an open platform for all types of terminal equipment (TE) to plug-in. (The Internet Engineering Task Force (IETF) is the principal standards body for the internet.) Meanwhile, the user benefits by being able to view media playing in the terminal equipment, such as a personal computer, much more comfortably. On the other hand, the mobile terminal does not need to read the data stream from the terminal equipment, which is a session initiation protocol) SIP signal and which is a real-time transport protocol (RTP) packet. The mobile terminal may only encapsulate the real-time transport protocol/real-time transport control protocol (RTP/RTCP) stream from the terminal equipment (e.g. in the internet protocol (IP) format) into the media packet data protocol (PDP) context to a calling party's internet protocol (IP) address. The mobile terminal becomes a key controller by solely handling SIP control signals.

Third, regarding battery consumption, the present invention provides a balanced solution in that the mobile terminal takes care of the session initiation protocol (SIP) signalling, while the terminal equipment takes care of the real-time transport protocol/real-time transport control protocol (RTP/RTCP) stream.

Finally, the mobile terminal may not necessarily need to request a separate internet protocol (IP) address for the terminal equipment. The mobile terminal's internet protocol (IP) address (both dynamic and static styles) would be sufficient. It's easy for the mobile terminal to forward information since the real-time transport protocol/real-time transport control protocol (RTP/RTCP) stream is carried in another packet data protocol (PDP) context than the session initiation protocol (SIP) signalling.

In total, the present invention provides for a new and unique split architecture, that enhances the mobile terminal's controller role by assigning the identification/authentication function always to the mobile terminal as long as the mobile terminal is available. Furthermore, since rich-call signalling and media are in simultaneous transmission, the call control function is assigned to the mobile terminal and the real-transport protocol and real-transport control protocol (RTP/RTCP) stream processing is assigned to the terminal equipment.

### BRIEF DESCRIPTION OF THE DRAWING

The drawing, not drawn to scale, includes the following Figures:

FIG. 1 shows a diagram of a known method and apparatus for connecting terminal equipment to a wireless network with a mobile terminal.

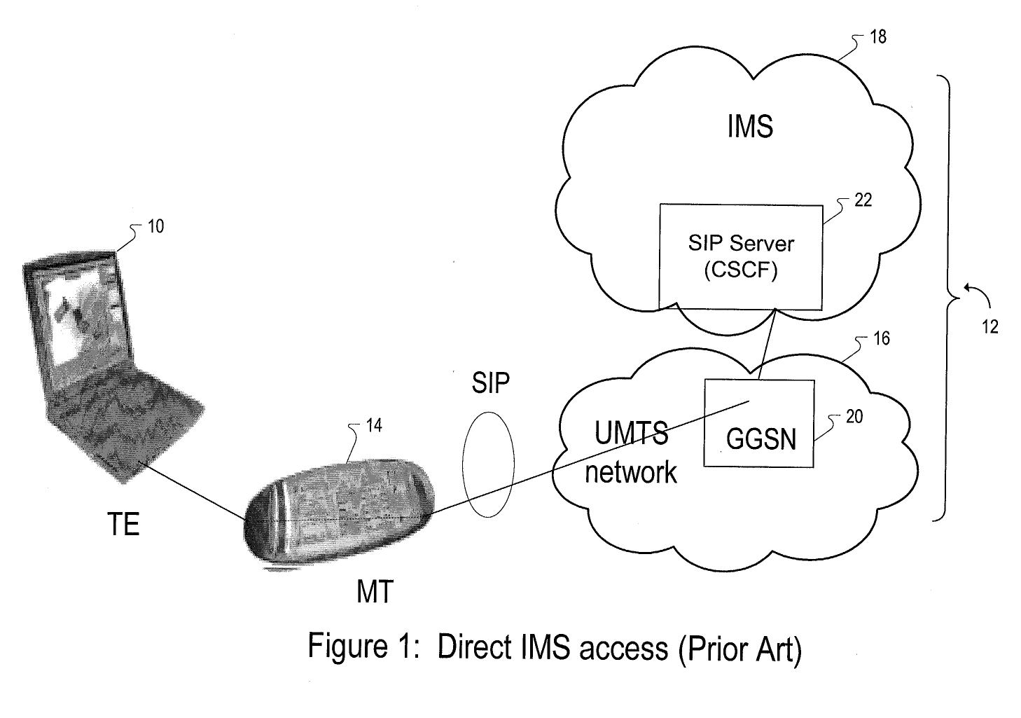

FIG. 2 shows a diagram of a method and apparatus for connecting terminal equipment with IMS proxy access via a mobile terminal to an internet protocol multimedia subsystem in a wireless network according to the present invention.

FIG. 3 shows a diagram of the mobile terminal shown in FIG. 2.

FIG. 4 shows a diagram of the terminal equipment shown in FIG. 2.

FIG. 5 shows the steps of an initiation procedure according to the present invention.

### DETAILED DESCRIPTION OF INVENTION

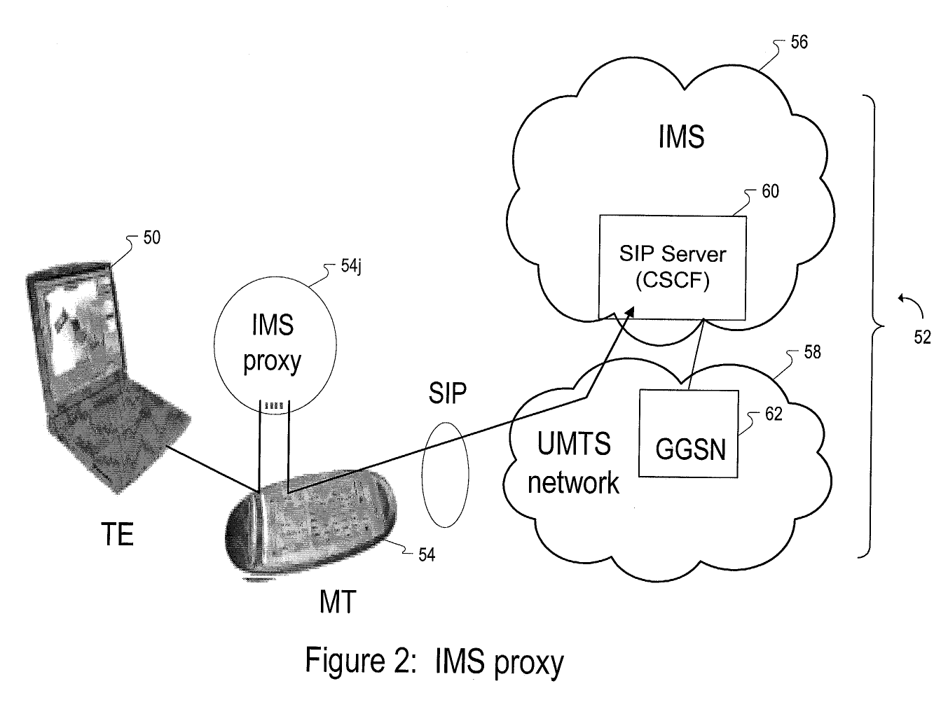

### FIG. 2: The Basic Invention

FIG. 2 shows a method and apparatus for connecting terminal equipment 50 to a wireless network 52 with a mobile terminal 54, wherein the mobile terminal 54 is assigned proxy functions generally indicated as 54j that control access of the terminal equipment 50 to the wireless network 52.

The wireless network 52 includes a universal mobile telecommunications system (UMTS) network 56 coupled to an internet protocol multimedia subsystem (IMS) 58. The communication protocol between the mobile terminal 54 and the internet protocol multimedia subsystem (IMS) 58 is a session initiation protocol (SIP). The universal mobile telecommunications system (UMTS) network 56 includes a gateway general packet radio system support node (GGSN) 60, while the internet protocol multimedia subsystem (IMS) 58 includes a session initiation protocol (SIP) server 62 to handle call state control functions. The proxy functions control the access of the terminal equipment 54 to the internet protocol multimedia subsystem (IMS) 56 in the wireless network 52. The session initiation protocol (SIP) server 60 of the internet protocol multimedia subsystem (IMS) 56 provides internet protocol multimedia signals to the terminal equipment 50.

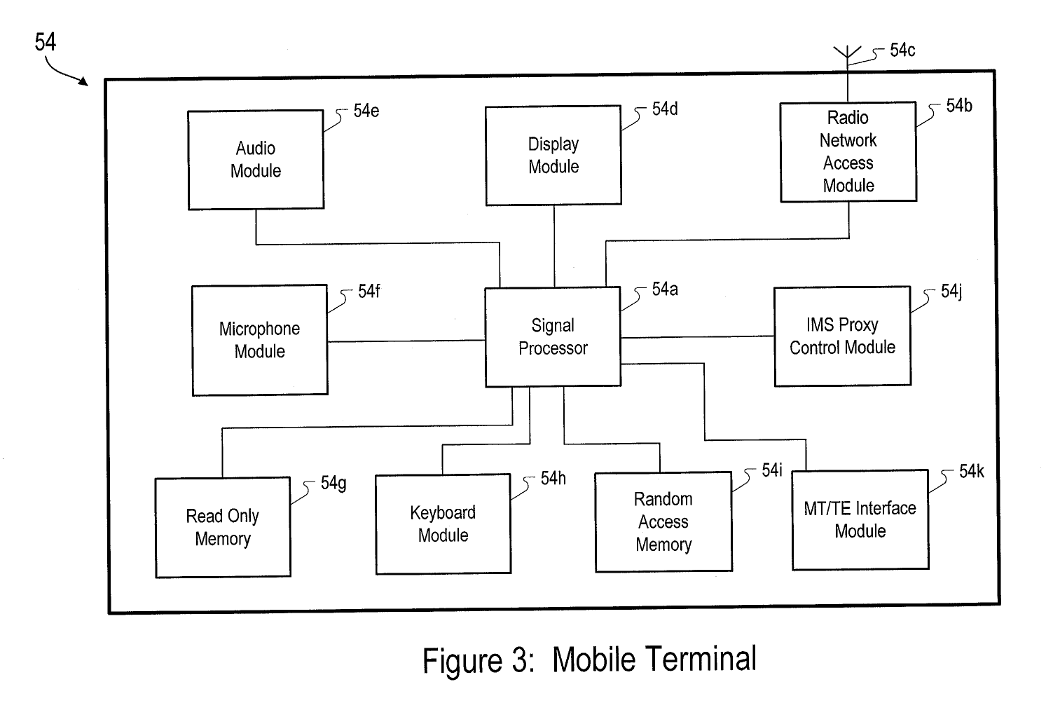

### FIG. 3: The Mobile Terminal 54

FIG. 3 shows a block diagram of the mobile terminal 54 shown in FIG. 2, and includes a signal processor 54a connected to a radio access network module 54b (connected to an antenna 54c), a display module 54d, an audio module 54e, a microphone 54f, a read only memory 54g (ROM or EPROM), a keyboard module 54h and a random access memory 54i (RAM). The signal processor 54a controls the basic operation of the wireless terminal 54, the operation of which is known in the art. Moreover, the scope of the invention is not intended to be limited to any particular kind or type of the aforementioned elements 54a, 54b, . . . , 54i. For example, the scope of the invention is intended to include the radio access network module 54b being either an antenna module, a radio frequency (RF) module, a radio modem or the like. The wireless terminal 54 may also include many other circuit elements known in the art which are not shown or described herein.

The mobile terminal 54 also includes an IMS proxy control module 54j assigned proxy functions that control access of the terminal equipment 50 to the wireless network 52. The proxy functions may include identification or authentication functions, as well as call control functions. In operation, the proxy functions include the mobile terminal 54 providing identification signals from the terminal equipment 50 to the wireless network 52 and application signals between the terminal equipment 50 to the wireless network 52, so as to act as an intermediary between the terminal equipment 50 and the wireless network 52.

The mobile terminal 54 also includes an MT/TE interface module 54k that retrieves identification information from the terminal equipment 50. The identification information may include adaptive multi-rate (AMR) codec information and real-time transport protocol (RTP) ciphering/deciphering capability information.

After receiving the identification information, the proxy control module 54j starts a connection to and negotiates capacity with the wireless network 52; considers the identification information as identifying itself and does not make any other mobile originated (MO) connections; and declares real-time transport protocol (RTP) session parameters and corresponding packet data protocol (PDP) contexts on behalf of the terminal equipment and handles the quality of service (QoS) independently. The proxy control module 54j may selectively change any real-time transport protocol (RTP) session parameter. After initiation is completed, the proxy control module 54j stores the identification information of the terminal equipment 50.

The IMS proxy control module 54j, the MT/TE interface module 54k or both may be implemented using hardware, software, or a combination thereof. In a typical software implementation, the IMS proxy control module 54j or the MT/TE interface module 54k would be a microprocessor-based architecture having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation.

The scope of the invention is not intended to be limited to any specific kind of mobile terminal or device, and many different mobile terminals or devices, including laptop or notebook computers, are envisioned that may contain the fundamental features of the present invention described herein.

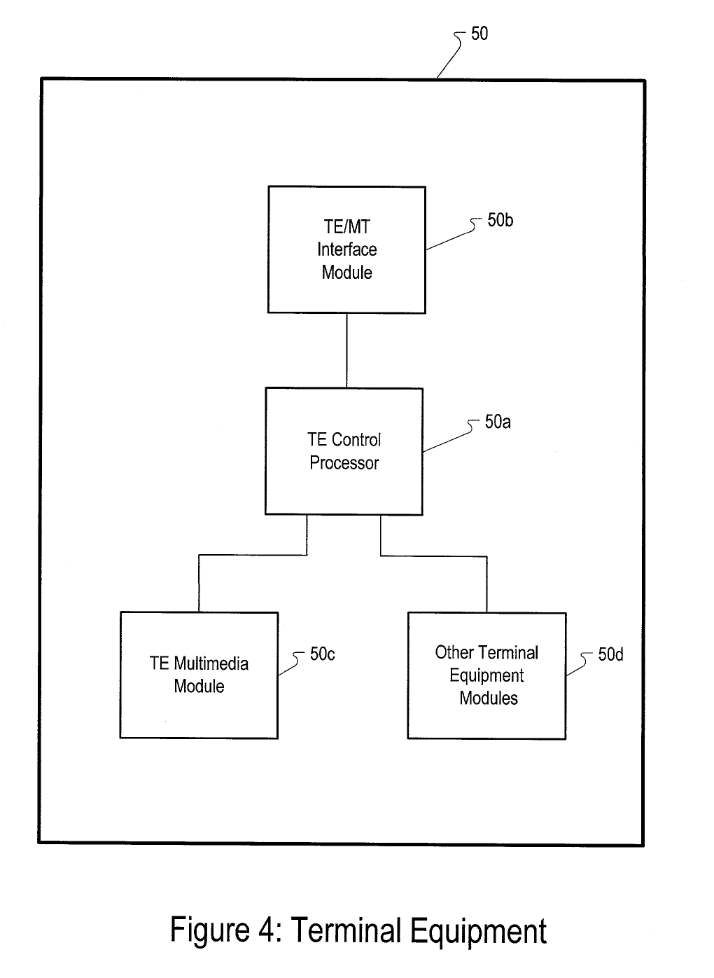

### FIG. 4: The Terminal Equipment 50

FIG. 4 shows the terminal equipment 50 having a TE control processor 50a, a TE/MT interface module 50b, a TE multimedia module 50c and other terminal equipment modules 50d. The TE control processor 50a controls the basic operation of the terminal equipment 50, the basic operation of which is known in the art. In the terminal equipment 50, the TE/MT interface module 50b controls interface functions between the terminal equipment 50 and the mobile terminal 54, and cooperates with the MT/TE interface module 54k (FIG. 3) of the mobile terminal 54. The TE multimedia module 50c performs protocol stream processing functions for communicating with the internet protocol multimedia subsystem (IMS). The protocol stream processing functions may include real-time transport protocol (RTP) and real-time transport control protocol (RTCP) functions. The other terminal equipment modules 50d are known in the art which are not shown or described herein, and the scope of the invention is not intended to be limited to any particular kind or type of the aforementioned modules 50d.

The TE/MT interface module 50b, TE multimedia module 50c, or both may be implemented using hardware, software, or a combination thereof. In a typical software implementation, the TE/MT interface module 50b or TE multimedia module 50c may be a microprocessor-based architecture having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation. The scope of the invention is not intended to be limited to any specific kind of such modules, and many different embodiments of these modules are envisioned that may contain the fundamental features of the present invention described herein.

### Initiation Procedure

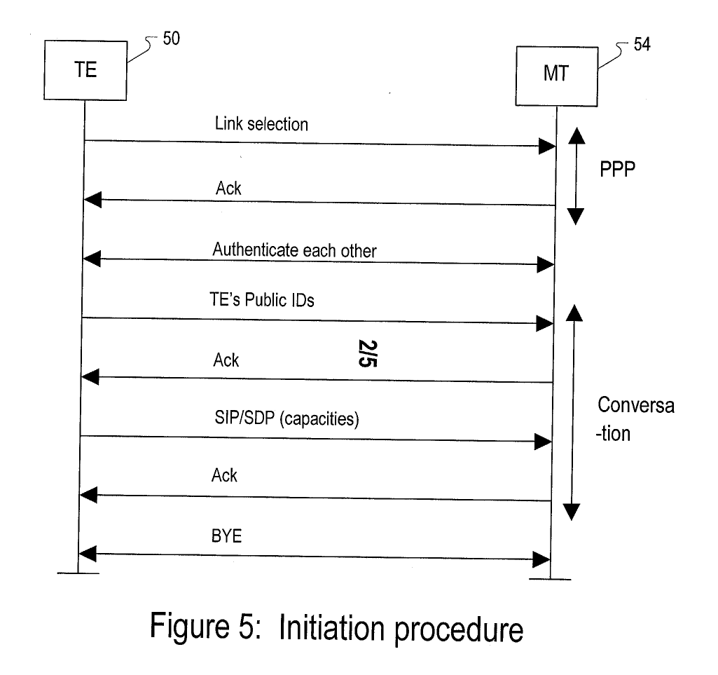

FIG. 5 shows the communication exchange between the terminal equipment 50 and the mobile terminal 54.

First, as a part of the point-to-point protocol (PPP), the terminal equipment 50 provides a link select signal to the mobile terminal 54, which acknowledges TE the acceptance of link selection. The terminal equipment 50 and mobile terminal 54 then authenticate each other by an authentication function built in the software or by existing technology for example Bluetooth.

Second, as part of a conversation, the terminal equipment 50 provides its public identification information (ID), which is acknowledged by the mobile terminal 54. The terminal equipment 50 then provides its SIP/SDP (capacities) which are again acknowledged by the mobile terminal 54. After the conversation to deliver the information of the terminal equipment 50, the terminal equipment 50 and mobile terminal 54 then end the initiation procedure.

If Bluetooth link is used, then the result of authentication of the application is reported to the mobile terminal 54. If the link is selected as a serial bus (SB), then the additional authentication is needed. In one embodiment, it is believe that authentication should involve the exchange of the respective equipment serial numbers.

### Media Description Parameters

The mobile terminal 54 needs all media description parameters defined in the session description protocol (SDP), including:

m=<media> <port> <transport> <fmt list> (media name and transport address, supported media code formats),

i=* (media title),

c=* <network type> <address type> <connection address> (connection information—optional if included at the session-level),

b=* <modifier>:<bandwidth-value> (bandwidth information),

k=* <method>:<encryption key> (encryption key), and

a=* <attribute>:<value> (zero or more media attribute lines about the supported formats).

The capacities should be listed in a SIP/SDP message. According to the session description protocol (SDP), it is permitted to concatenate multiple session descriptions together. If the terminal equipment 50 supports several media combination, then they can be described one by one.

It is noted that the encryption key for the real-time transport and real-time transport control protocol (RTP/RTCP) stream is generated in the mobile terminal 54. It is the responsibility of the mobile terminal 54 to forward the encryption key to the terminal equipment 50 TE before activating RTP processing.

### The TE-MT Functionality Split

The aforementioned TE-MT functionality split of the present invention is scheduled in the 3GPP Rel6 timeframe. The simplest case may be handled within the R5 timeframe where a USIM card will be used for identity and only a single terminal equipment is connected to the mobile terminal. The interface between the two equipments is called the R interface.

The high-level functionality partition will lead to a new architecture. There are at least 4 alternatives to achieve the functionality split where the role of the mobile terminal will be:

a. A modem,

b. A PDP context forwarder, the terminal equipment shall start a PDP context from its own point,

c. an IP router, the terminal equipment will acquire its own IP address,

d. a SIP UA/Proxy, or

e. Any others.

The goal of the present invention is to build an architecture in which the mobile terminal no longer has a dumb radio role. The key point is to keep the control point of the R interface inside the mobile terminal. In this way the mobile terminal is a service provision platform, and laptop/personal digital assistant (PDA)/camera are considered as the mobile's intelligent accessories. The motivation of this internet protocol routing (IPR) is to find the key points on security aspects.

### Advantages

The present invention provides an architecture that enhances the role of the mobile terminal 54 in a TE-MT functionality split. The advantage is to define the mobile terminal's essential controller role in IMS service access.

In operation, an initiation application is made in which the identification of the terminal equipment 50 is forwarded or delegated to the mobile terminal 54. Also information for advertisement of conference sessions and relevant conference setup is provided to prospective participants. The application can be similar as PC suite for all Nokia phones. The application can sense the available link connections, such as Bluetooth, Infrared, wire, and select the preferred one. After obtaining the information, the mobile terminal 54 would start the connection on behalf of the terminal equipment 50. In this scenario, the mobile terminal 54 shall consider the identification of the terminal equipment 50 as the identification of the mobile terminal 54, and does not make any other mobile originated (MO) connection.

The SIP session always starts from the mobile terminal 54. The mobile terminal (after registering) sends INVITE by using the identification information (ID) of the terminal equipment 50 in the contact header:

TE_IMPU@MT_receiving_port_number:MT_IP_address.

The mobile terminal 54 declares the RTP session parameters and corresponding PDP contexts on behalf of the terminal equipment 50. In this way, those authorization tokens for the quality of service (QoS) are not needed to be forwarded to the terminal equipment 50. In other words, the mobile terminal 54 handles the quality of service (QoS) independently. The media stream is transferred between the terminal equipment 50 and the mobile terminal 54 via, for example, universal serial bus (USB) or an Infrared connection. The mobile terminal 54 looks like a remote controller and the terminal equipment 50 can, for example, function as a television screen.

When the mobile terminal 54 wants to change any parameter of RTP session, it can control freely as if the RTP is processed inside the mobile terminal 54. Certainly any new parameters must be supported by the terminal equipment 50 advertised during initiation.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

I claim:

1. A method for connecting terminal equipment to a wireless network with a mobile terminal, characterized in that the mobile terminal is assigned proxy functions that control the access of the terminal equipment to the wireless network.

2. A method according to claim 1, characterized in that the proxy functions control the access of the terminal equipment to an internet protocol multimedia subsystem (IMS) in the wireless network.

3. A method according to claim 2, characterized in that the proxy functions include identification or authentication functions.

4. A method according to claim 3, characterized in that proxy functions include call control functions.

5. A method according to claim 1, characterized in that the proxy functions include the mobile terminal providing identification signals from the terminal equipment to the wireless network and application signals between the terminal equipment to the wireless network, so as to act as an intermediary between the terminal equipment and the wireless network.

6. A method according to claim 2, characterized in that the terminal equipment performs multimedia stream processing functions for communicating with the internet protocol multimedia subsystem (IMS).

7. A method according to claim 6, characterized in that the multimedia stream processing functions include real-time transport protocol (RTP) and real-time transport control protocol (RTCP) functions.

8. A method according to claim 2, characterized in that the wireless network includes a universal mobile telecommunications system (UMTS) network coupled to the internet protocol multimedia subsystem (IMS).

9. A method according to claim 2, characterized in that the internet protocol multimedia subsystem (IMS) includes a session initiation protocol (SIP) server for providing internet protocol multimedia information signal.

10. A method according to claim 1, characterized in that the mobile terminal retrieves identification information from the terminal equipment if there is any previously defined.

11. A method according to claim 10, characterized in that the identification information includes adaptive multi-rate (AMR) codec information and real-time transport protocol (RTP) ciphering/deciphering capability information.

12. A method according to claim 10, characterized in that, after receiving the identification information, the mobile terminal starts a connection to and negotiates capacity with the wireless network.

13. A method according to claim 10, characterized in that, after receiving the identification information, the mobile terminal considers the identification information as identifying itself; and then when aiding the terminal equipment to make a call to the internet protocol multimedia subsystem (IMS), the mobile terminal does not make any other mobile originated (MO) connections since the mobile terminal considers the identification information as identifying itself.

14. A method according to claim 10, characterized in that, after receiving the identification information, the mobile terminal declares the real-time transport protocol (RTP) session parameters and corresponding packet data protocol (PDP) contexts on behalf of the terminal equipment and handles the quality of service (QoS) independently.

15. A method according to claim 10, characterized in that the mobile terminal starts a session initiation protocol (SIP) session and declares real transport protocol (RTP) session parameters and corresponding packet data protocol (PDP) contexts on behalf of the terminal equipment, and also handles independently the quality of service (QoS) of the terminal equipment.

16. A method according to claim 10, characterized in that the mobile terminal selectively changes any realtime transport protocol (RTP) session parameter for the quality of service (QoS) available from the current connection.

17. A method according to claim 10, characterized in that, after initiation is completed, the mobile terminal stores the identification information of the terminal equipment.

18. A mobile terminal for connecting terminal equipment to a wireless network, characterized in that the mobile terminal includes a proxy control module assigned proxy functions that control access of the terminal equipment to the wireless network.

19. A mobile terminal according to claim 18, characterized in that the proxy functions control the access of the terminal equipment to an internet protocol multimedia subsystem (IMS) in the wireless network.

20. A mobile terminal according to claim 19, characterized in that the proxy functions include identification or authentication functions.

21. A mobile terminal according to claim 20, characterized in that the proxy functions include call control functions.

22. A mobile terminal according to claim 18, characterized in that the proxy functions include the mobile terminal providing identification signals from the terminal equipment to the wireless network and application signals between the terminal equipment to the wireless network, so as to act as an intermediary between the terminal equipment and the wireless network.

23. A mobile terminal according to claim 18, characterized in that the terminal equipment includes an internet protocol multimedia subsystem (IMS) module that performs multimedia stream processing functions for communicating with the internet protocol multimedia subsystem (IMS).

24. A mobile terminal according to claim 23, characterized in that the multimedia stream processing functions includes real-time transport protocol (RTP) and real-time transport control protocol (RTCP) functions.

25. A mobile terminal according to claim 19, characterized in that the wireless network includes a universal mobile telecommunications system (UMTS) network coupled to the internet protocol multimedia subsystem (IMS).

26. A mobile terminal according to claim 25, characterized in that the internet protocol multimedia subsystem (IMS) includes a session initiation protocol (SIP) server for providing internet protocol multimedia signals.

27. A mobile terminal according to claim 18, characterized in that the mobile terminal includes an interface module that retrieves identification information from the terminal equipment.

28. A mobile terminal according to claim 27, characterized in that the identification information includes adaptive multi-rate (AMR) codec information and real-time transport protocol (RTP) ciphering/deciphering capability information.

29. A mobile terminal according to claim 27, characterized in that, after receiving the identification information, the proxy control module starts a connection to and negotiates capacity with the wireless network.

30. A mobile terminal according to claim 27, characterized in that, after receiving the identification information, the proxy control module considers the identification information as identifying itself and does not make any other mobile originated (MO) connections when the terminal equipment is connecting to the internet protocol multimedia subsystem (IMS).

31. A mobile terminal according to claim 27, characterized in that, after receiving the identification information, the mobile terminal considers the identification information as identifying itself; and when the terminal equipment starts a connection, the proxy control module in the mobile terminal declares the real-time transport protocol (RTP) session parameters and corresponding packet data protocol (PDP) contexts on behalf of the terminal equipment and handles the quality of service (QoS) independently.

32. A mobile terminal according to claim 27, characterized in that the proxy control module starts a session initiation protocol (SIP) session and declares real transport protocol (RTP) session parameters and corresponding packet data protocol (PDP) contexts on behalf of the terminal equipment, and also handles independently the quality of service (QoS) of the terminal equipment.

33. A mobile terminal according to claim 27, characterized in that the proxy control module selectively changes any real-time transport protocol (RTP) session parameter for the quality of service (QoS) available from the current connection.

34. A mobile terminal according to claim 27, characterized in that, after initiation is completed, the proxy control module stores the identification information of the terminal equipment.

35. A mobile terminal able to communicate both with a terminal equipment using a selected interface and with a network using a wireless interface, comprising:
means, responsive to an identification signal from said terminal equipment indicative of identification information of said terminal equipment or of a user thereof, for storing said identification signal; and
means, responsive to application signals from said terminal equipment and said network for acting as an intermediary therebetween using said stored identification signal to identify said terminal equipment or user to said network.
